(19) United States
(12) Patent Application Publication
(10) Pub. No.: US 2016/0148059 A1
(43) Pub. Date: May 26, 2016

(54) TRAVEL LANE MARKING RECOGNITION APPARATUS

(71) Applicant: DENSO CORPORATION, Kariya-city (JP)

(72) Inventors: Taiki Kawano, Nishio-shi (JP); Naoki Kawasaki, Kariya-shi (JP); Tomohiko Tsuruta, Nukata-gun (JP); Shunsuke Suzuki, Kariya-shi (JP)

(21) Appl. No.: 14/949,593

(22) Filed: Nov. 23, 2015

(30) Foreign Application Priority Data
Nov. 25, 2014 (JP) 2014-238077

(51) Int. Cl. G06K 9/00; G06T 11/20

(52) U.S. Cl. CPC G06K 9/00798; G06T 11/203

(57) ABSTRACT

A travel lane marking recognition apparatus includes a recognizing unit that is mounted to a vehicle. The recognizing unit uses a recognition model to recognize a lane marking that demarcates a lane on a road, based on an image of an area ahead of the vehicle captured by an on-board camera. The recognition model is configured by a plurality of recognition models that includes at least two recognition models among a first-order model that takes into consideration a straight line, a second-order model that takes into consideration a steady curve, and a third-order model that takes into consideration a clothoid curve. The recognizing unit is configured to recognize the lane marking by integrating recognition results acquired using the plurality of recognition models based on a state of the vehicle.

### CROSS-REFERENCE TO RELATED APPLICATION

This application is based on and claims the benefit of priority from Japanese Patent Application No. 2014-238077, filed Nov. 25, 2014. The entire disclosure of the above application is incorporated herein by reference.

### BACKGROUND

1. Technical Field

The present disclosure relates to a travel lane marking recognition apparatus that recognizes a travel lane marking that demarcates a lane, to provide a vehicle with driving assistance and the like.

2. Related Art

Conventionally, travel lane marking recognition apparatuses have been proposed that recognize a travel lane marking that demarcates a lane on a road to provide a vehicle with driving assistance. As such an apparatus, there is an apparatus that recognizes a travel lane marking by using different recognition models for an area near the vehicle and an area far from the vehicle, to recognize even distant travel lane markings, as does the apparatus described in JP-A-2013-196341.

When recognition of even a distant travel lane marking is to be made, a long-range recognition model is required to be used. However, depending on the state of the road, recognition of travel lane markings may become unstable when the long-range recognition model is used. For example, when the long-range recognition model is used in a case in which a distant travel lane marking is not visible from the vehicle during traffic congestion, recognition of travel lane markings may become unstable.

### SUMMARY

It is thus desired to provide a travel lane marking recognition apparatus that is capable of actualizing highly robust recognition of travel lane markings in various vehicle states.

A first exemplary embodiment of the present disclosure provides a travel lane marking recognition apparatus including a recognition unit that is mounted to a vehicle. The recognition unit uses a recognition model to recognize a lane marking that demarcates a lane on a road, based on an image of an area ahead of a vehicle captured by an on-board camera. The recognition model is configured by a plurality of recognition models that include at least two recognition models among a first-order model that takes into consideration a straight line, a second-order model that takes into consideration a steady curve, and a third-order model that takes into consideration a clothoid curve. The recognition unit is configured to recognize the lane marking by integrating recognition results acquired using a plurality of recognition models based on a state of the vehicle.

In the first exemplary embodiment, at least two recognition models, among the first-order model, the second-order model, and the third-order model, are used to recognize the travel lane marking. The recognition results acquired using the plurality of recognition models are integrated based on the vehicle state, and the lane marking is recognized. Therefore, a highly robust recognition of lane markings can be actualized in various vehicle states.

A second exemplary embodiment of the present disclosure provides a travel lane marking recognition apparatus including a recognition unit that is mounted to a vehicle. The recognition unit uses that uses a recognition model to recognize a lane marking that demarcates a lane on a road, based on an image of an area ahead of a vehicle captured by an on-board camera. The recognition model is configured by a plurality of recognition models that include at least two recognition models among a first-order model that takes into consideration a straight line, a second-order model that takes into consideration a steady curve, and a third-order model that takes into consideration a clothoid curve. The recognition unit is configured to recognize the lane marking by changing the plurality of recognition models to be used based on the vehicle state.

In the second exemplary embodiment, at least two recognition models, among the first-order model, the second-order model, and the third-order model, are used to recognize the travel lane marking. The recognition model to be used is changed based on the vehicle state. Therefore, a highly robust recognition of lane markings can be actualized in various vehicle states.

A third exemplary embodiment of the present disclosure provides a travel lane marking recognition apparatus including a recognition unit that is mounted to a vehicle. The recognition unit uses a recognition model to recognize a lane marking that demarcates a lane on a road, based on an image of an area ahead of a vehicle captured by an on-board camera. The recognition model is configured by a plurality of recognition models that include at least two recognition models among a short-range model specific for short distances, a medium-range model specific for intermediate distances, and a long-range model specific for long distances. The recognition unit is configured to recognize the lane marking by integrating recognition results acquired using a plurality of recognition models based on a state of the vehicle.

In third exemplary embodiment, effects similar to those of the first exemplary embodiment are achieved.

A fourth exemplary embodiment of the present disclosure provides a travel lane marking recognition apparatus including a recognition unit that is mounted to a vehicle. The recognition unit uses a recognition model to recognize a lane marking that demarcates a lane on a road, based on an image of an area ahead of a vehicle captured by an on-board camera. The recognition model is configured by a plurality of recognition models that include at least two recognition models among a short-range model specific for short distances, a medium-range model specific for intermediate distances, and a long-range model specific for long distances. The recognition unit is configured to recognize the lane marking by changing the plurality of recognition models to be used based on the vehicle state.

In the fourth exemplary embodiment, effects similar to those of the second exemplary embodiment are achieved.

### BRIEF DESCRIPTION OF THE DRAWINGS

In the accompanying drawings:

FIG. 1 is a block diagram of an overall configuration of a travel lane marking recognition apparatus according to a first embodiment;

FIG. 2 is a flowchart of a white line recognition process according to the first embodiment;

FIG. 3 is a flowchart of a nearby white line recognition process;

FIG. 4 is a flowchart of an intermediate-distance white line recognition process;

FIG. 5 is a flowchart of a distant white line recognition process;

FIG. 6 is a block diagram of an overall configuration of a travel lane marking recognition apparatus according to a second embodiment; and

FIG. 7 is a flowchart of a white line recognition process according to the second embodiment.

### DESCRIPTION OF THE EMBODIMENTS

Each embodiment actualizing a travel lane marking recognition apparatus will hereinafter be described with reference to the drawings. The travel lane markings recognized by the travel lane marking recognition apparatus according to each embodiment are used for driving assistance, such as lane keeping assist control (LKA control) and lane deviation warning. Sections among the embodiments below that are identical or equivalent are given the same reference numbers in the drawings. Descriptions of sections having the same reference numbers are supported among one another.

### First Embodiment

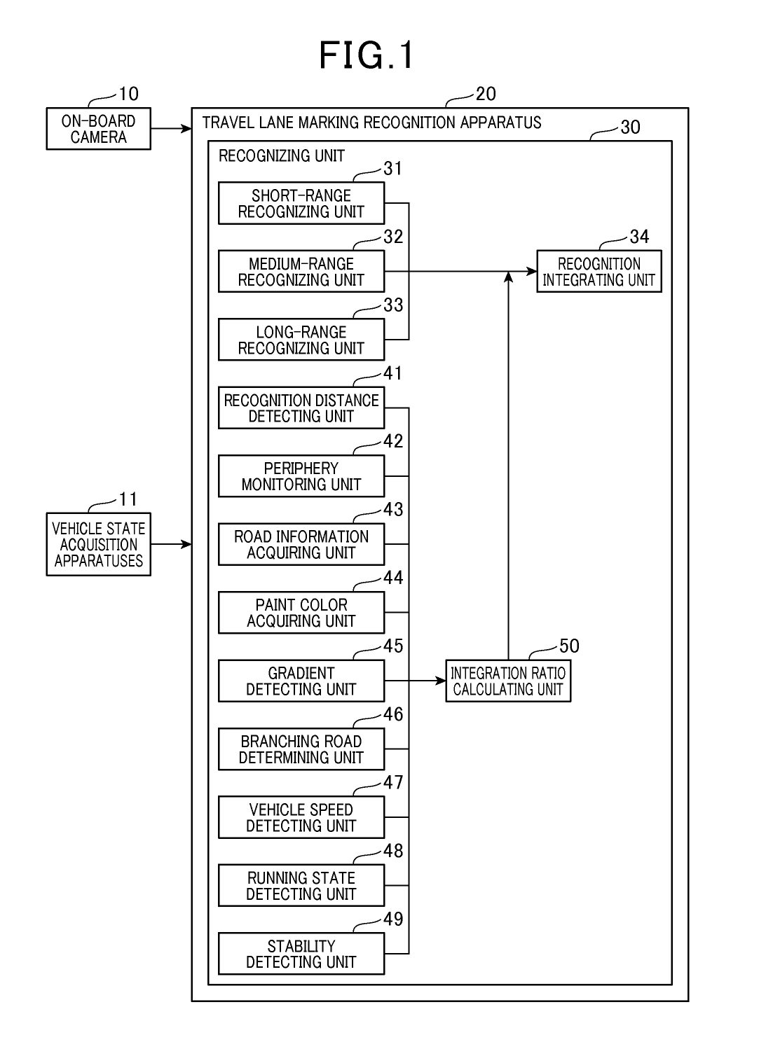

First, a configuration of a travel lane marking recognition apparatus 20 according to the present embodiment will be described with reference to FIG. 1. The travel lane marking recognition apparatus 20 recognizes a white line (lane marking) that demarcates a lane on a road, based on an image captured by an on-board camera 10 and information acquired by vehicle state acquisition apparatuses 11. Here, the white line also refers to a yellow line that demarcates a lane.

The on-board camera 10 is a charge-coupled device (CCD) camera, a complementary metal-oxide-semiconductor (CMOS) camera, or the like. The on-board camera 10 is attached to the front side of the vehicle, in the center in the vehicle width direction, such as in the center of a rearview mirror. The on-board camera 10 captures images of a road ahead of the vehicle.

The vehicle state acquisition apparatuses 11 refers to various apparatuses that acquire information indicating the vehicle state. The vehicle state includes the state surrounding the vehicle and the behavior of the vehicle. For example, the vehicle state includes information on solid objects in the periphery of the own vehicle, the road surface environment of the road, attributes of the road, information on the color of the road surface paint on the road, the amount of change in road gradient, information on branching roads, vehicle speed, and a running state such as the pitch angle and the roll angle.

Specifically, the vehicle state acquisition apparatuses 11 are various apparatuses, such as a stereo camera, a peripheral camera, a millimeter wave radar, a laser radar, an ultrasonic sensor, a temperature sensor, a rain sensor, a vehicle speed sensor, a yaw rate sensor, an angle sensor, a global positioning system (GPS) receiver, a map storage unit, an inter-vehicle communication apparatus, and a road-vehicle communication apparatus.

The stereo camera and the peripheral camera detect other vehicles, pedestrians, and solid objects, which are roadside objects, in the periphery of the vehicle from captured images. Furthermore, the stereo camera detects the gradient of the road, as well as the shape of the road, such as a curve. The millimeter wave radar, the laser radar, and the ultrasonic sensor detect other vehicles, pedestrians, and solid objects, which are roadside objects, in the periphery of the vehicle. The temperature sensor detects the outside temperature. The rain sensor detects the amount of rainfall.

The vehicle speed sensor detects the wheel speed, that is, the vehicle speed. The yaw rate sensor detects the yaw rate of the vehicle. The angle sensor detects the pitch angle and the roll angle of the vehicle. The GPS receiver acquires information on the current position of the vehicle and the current time, based on signals transmitted from a GPS satellite. The inter-vehicle communication apparatus receives information from another vehicle that is provided with an inter-vehicle communication apparatus. The received information is on the position and speed of the other vehicle. The road-side communication apparatus receives information from a roadside unit. The received information includes information on the positions of roadside objects (solid objects) such as guardrails, information on the positions of solid objects such as other vehicles and pedestrians, and the shape and attributes of the road.

The travel lane marking recognition apparatus 20 is a known microcomputer that includes a central processing unit (CPU), a read-only memory (ROM), a random access memory (RAM), an input/output (I/O), and the like. The CPU runs various programs stored in the ROM, thereby actualizing the functions of a recognizing unit 30.

The recognizing unit 30 (recognizing means) recognizes a white line on the road using recognition models. The recognition models include a short-range model, a medium-range model, and a long-range model. In addition, the recognizing unit 30 includes a short-range recognizing unit 31, a medium-range recognizing unit 32, a long-range recognizing unit 33, and a recognition integrating unit 34. Furthermore, the recognizing unit 30 also includes a recognition distance detecting unit 41, a periphery monitoring unit 42, a road information acquiring unit 43, a paint color acquiring unit 44, a gradient detecting unit 45, a branching road determining unit 46, a vehicle speed detecting unit 47, a running state detecting unit 48, a stability detecting unit 49, and an integration ratio calculating unit 50.

The short-range recognizing unit 30 recognizes a white line near the vehicle using the short-range model, based on an image captured by the on-board camera 10. That is, the short-range recognizing unit 31 estimates white line parameters using the short-range model. The short-range model includes, for example, a first-order model that takes into consideration a straight line and a short-range model specific for short distances. The short-range model specific for short distances is a model that is based on the first-order model and also takes into account another model. For example, the short-range model specific for short distances is a model that is based on the first-order model and takes into account a second-order model, or a model that is based on the first-order model and takes into account a third-order model.

The medium-range recognizing unit 32 recognizes a white line at an intermediate distance between the area near the vehicle and the area far from the vehicle, using the medium-range model, based on an image captured by the on-board camera 10. That is, the medium-range recognizing unit 32 estimates the white line parameters using the medium-range model. The medium-range model includes a second-order model that takes into consideration a steady curve and a medium-range model specific for intermediate distances. The medium-range model specific for intermediate distances is a model that is based on the second-order model and also takes into account another model. For example, the medium-range model specific for intermediate distances is a model that is based on the second-order model and takes into account a third-order model, or a model that is based on the second-order model and takes into account the first-order model.

The long-range recognizing unit 33 recognizes a white line far from the vehicle using the long-range model, based on an image captured by the on-board camera 10. That is, the long-range recognizing unit 33 estimates the white line parameters using the long-range model. The long-range model includes, for example, a third-order model that takes into consideration a clothoid curve and a long-range model specific for long distances. The long-range model specific for long distances is a model that is based on the third-order model and also takes into account another model. For example, the long-range model specific for long distances is a model that is based on the third-order model and takes into account the second-order model, or a model that is based on the third-order model and takes into account the first-order model.

The recognition integrating unit 34 integrates the recognition results from the short-range recognizing unit 31, the medium-range recognizing unit 32, and the long-range recognizing unit 33 using an integration ratio calculated by the integration ratio calculating unit 50, described hereafter. The recognition integrating unit 34 thereby recognizes a white line.

The recognition distance detecting unit 41 (recognition distance detecting means) detects a recognition distance, which is the distance at which the white line is recognized. Specifically, the recognition distance detecting unit 41 detects the distance to the edge point farthest from the vehicle, among the edge points included in the white line recognized by the short-range recognizing unit 31, the medium-range recognizing unit 32, and the long-range recognizing unit 33, as the recognition distance.

The periphery monitoring unit 42 (solid object information acquiring means) acquires solid object information of the periphery of the vehicle based on information acquired from the various apparatuses of the vehicle state acquisition apparatuses 11. The solid object information includes the distance from the vehicle to the solid object, the position in the lateral direction (vehicle width direction) of the solid object, and the relative speed of the solid object in relation to the vehicle.

The road information acquiring unit 43 (road information acquiring means) acquires the road surface environment of the road or the attributes of the road based on information acquired from the various apparatuses of the vehicle state acquisition apparatuses 11. The road surface environment of the road includes a road surface wet with rain, a snowy road on which snow is accumulated on the road surface, a gravel road, nighttime, a faded white line, or the like. The attributes of the road include an expressway, a city street which is a local road, a bypass road, a mountain road, or the like.

The paint color acquiring unit 44 (color acquiring means) acquires color information of the road surface paint based on an image captured by the on-board camera 10. Specifically, the paint color acquiring unit 44 acquires any of white, yellow, blue, and orange as the color of a marking on the road surface.

The gradient detecting unit 45 (gradient detecting means) detects the amount of change in the gradient of the road based on information acquired from the various apparatuses of the vehicle state acquisition apparatuses 11.

The branching road determining unit 46 (branching road determining means) determines whether or not the lane is a branching road, based on information acquired from the various apparatuses of the vehicle state acquisition apparatuses 11.

The vehicle speed detecting unit 47 (vehicle speed detecting means) detects the speed of the vehicle based on a detection value from the vehicle speed sensor.

The running state detecting unit 48 (running state detecting means) detects the running state of the vehicle based on information acquired from the various apparatuses of the vehicle state acquisition apparatuses 11. Specifically, the running state detecting unit 48 detects the pitch angle and the roll angle of the vehicle based on the detection values from the angle sensor. In addition, for example, the running state detecting unit 48 detects the acceleration of the drive wheel from the wheel speed detected by the vehicle speed sensor, and detects skidding by the vehicle by comparing the acceleration and a reference acceleration.

The stability detecting unit 49 (stability detecting means) detects the stability of white line recognition for each of the short-range model, the medium-range model, and the long-range model. Specifically, the stability detecting unit 49 detects the stability of white line recognition by each of the short-range recognizing unit 31, the medium-range recognizing unit 32, and the long-range recognizing unit 33, based on the variations in past recognition results of each of the short-range recognizing unit 31, the medium-range recognizing unit 32, and the long-range recognizing unit 33. The stability detecting unit 49 calculates the stability of white line recognition to be relatively high when the variations in white line parameters estimated in the past are relatively small. The stability detecting unit 49 calculates the stability of white line recognition to be relatively low when the variations in white line parameters estimated in the past are relatively large.

The integration ratio calculating unit 50 calculates the integration ratio of the recognition results from the short-range recognizing unit 31, the medium-range recognizing unit 32, and the long-range recognizing unit 33, based on the vehicle state. That is, the integration ratio calculating unit 50 calculates the integration ratio based on the recognition distance, the solid object information, the road surface environment or attributes of the road, the color of the road surface paint, the amount of change in the gradient of the road, the branching road determination result, the vehicle speed, the running state, and the stability of each recognition model. The method for calculating the integration ratio will be described below.

As the recognition distance becomes shorter, seeing the white line over a long distance become difficult. Therefore, the integration ratio calculating unit 50 calculates the integration ratio such that the usage rate of the low-order model is higher than that of the high-order model as the recognition distance becomes shorter. In addition, as the number of solid objects in the periphery of the vehicle increases, seeing the white line over a long distance becomes difficult. Therefore, the integration ratio calculating unit 50 calculates the integration ratio such that the usage rate of the low-order model is higher than that of the high-order model as the number of solid objects in the periphery of the vehicle increases.

When the road surface is wet, light is reflected on the road surface and distant areas become difficult to see. Therefore, when the road surface is wet, the integration ratio calculating unit 50 calculates the integration ratio such that the usage rate of the low-order model is higher than that of the high-order model. In addition, seeing the white line over a long distance on a snowy road or on a gravel road is difficult. Therefore, when the road surface is that of a snowy road or a gravel road, the integration ratio calculating unit 50 calculates the integration ratio such that the usage rate of the low-order model is higher than that of the high-order model. Furthermore, distant areas are difficult to see due to headlights during nighttime. Therefore, during nighttime, the integration ratio calculating unit 50 calculates the integration ratio such that the usage rate of the low-order model is higher than that of the high-order model.

In addition, because more obstructions are present on local roads than on expressways, seeing the white line over a long distance is difficult on a local road. Therefore, when the road is a local road, the integration ratio calculating unit 50 calculates the integration ratio such that the usage rate of the low-order model is higher than that when the road is an expressway. Furthermore, many curves are present on mountain roads. Therefore, when the road is a mountain road, the integration ratio calculating unit 50 calculates the integration ratio such that the usage rate of the high-order model is higher than that of the low-order model.

When the road surface paint on the road is yellow, or in other words, the lane marking is yellow, the lane marking may indicate that a construction zone is present ahead (such as in Germany). Because numerous obstructions are present in a construction zone, when the road surface paint on the road is yellow, the integration ratio calculating unit 50 calculates the integration ratio such that the usage rate of the low-order model is higher than that of the high-order model.

At a location where the amount of change in the gradient of the road is greater than a predetermined amount, such as at an entrance onto a slope, a distant white line is easily erroneously recognized. Therefore, when the amount of change in the gradient of the road is greater than the predetermined amount, the integration ratio calculating unit 50 calculates the integration ratio such that the usage rate of the low-order model is higher than that of the high-order model.

On a branching road in which the lane branches off up ahead, the white line that is farther than the branching portion is required to be recognized in order to stably recognize white lines. Therefore, when the lane is determined to be a branching road, the integration ratio calculating unit 50 calculates the integration ratio such that the usage rate of the high-order model is higher than that of the low-order model.

When the vehicle speed is low, the likelihood of traffic congestion is high. The likelihood is high that the white line is difficult to see over a long distance. In addition, when the vehicle speed is high, the likelihood is high that the white line can be easily seen over a long distance. Therefore, the integration ratio calculating unit 50 calculates the integration ratio such that the usage rate of the low-order model is higher than that of the high-order model as the vehicle speed decreases. The integration ratio calculating unit 50 calculates the integration ratio such that the usage rate of the high-order model is higher than that of the low-order model as the vehicle speed increases.

When the vehicle is pitching or rolling at a degree greater than a predetermined angle or when the vehicle skids, and the vehicle is in an unstable running state, a distant white line is easily erroneously recognized. Therefore, when the pitch angle or the roll angle of the vehicle is greater than predetermined angles, the integration ratio calculating unit 50 calculates the integration ratio such that the usage rate of the low-order model is higher than that of the high-order model. In addition, when the vehicle skids, the integration ratio calculating unit 50 calculates the integration ratio such that the usage rate of the low-order model is higher than that of the high-order model.

When a model having high stability is preferentially used, the stability of white line recognition increases. Therefore, the integration ratio calculating unit 50 calculates the integration ratio such that the usage rate of the recognition model having higher stability becomes higher.

The integration ratio calculating unit 50 calculates each integration ratio based on each vehicle state. The integration ratio calculating unit 50 then integrates the calculated integration ratio and calculates the integration ratio to be used for integration of the recognition results.

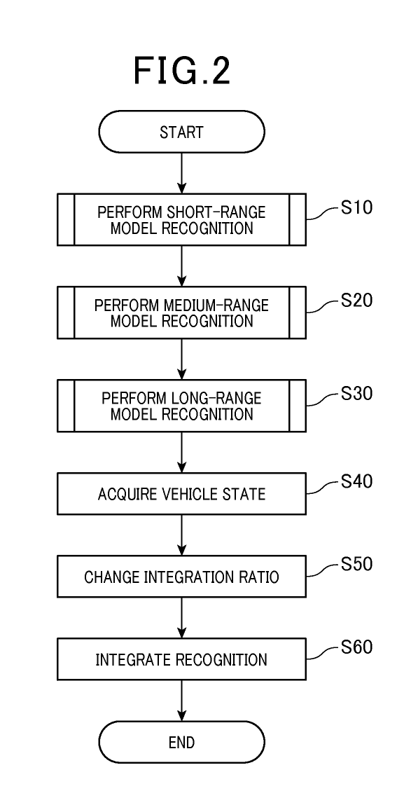

Next, a process for recognizing the white line will be described with reference to the flowchart FIG. 2. The present process is performed by the travel lane marking recognition apparatus 20 each time an image is captured by the on-board camera 10.

First, the travel lane marking recognition apparatus 20 recognizes a white line near the vehicle using the short-range model, based on the image captured by the on-board camera 10 (step S10). Details of the white line recognition performed using the short-range model will be described hereafter.

Next, the travel lane marking recognition apparatus 20 recognizes the white line at an intermediate distance from the vehicle using the medium-range model, based on the image captured by the onboard camera 10 (step S20). Details of the white line recognition performed using the medium-range model will be described hereafter.

Next, the travel lane marking recognition apparatus 20 recognizes the white line at a long distance from the vehicle using the long-range model, based on the image captured by the onboard camera 10 (step S30). Details of the white line recognition performed using the long-range model will be described hereafter.

Here, the order in which the processes at S 10 to S30 are performed is not limited to the above-described order. The processes are merely required to be performed based on any of patterns 1 to 7, below.

### (Pattern 1)

The processes are performed in order from steps S10 to S20 to S30. The recognition process at step S20 is performed using the recognition result at step S10. The recognition process at step S30 is performed using both the recognition result at step S 10 and the recognition result at step S20, or either of the recognition result at step S10 and the recognition result at step S20.

### (Pattern 2)

The processes are performed in order from steps S10 to S30 to S20. The recognition process at step S30 is performed using the recognition result at step S10. The recognition process at step S20 is performed using both the recognition result at step S10 and the recognition result at step S30, or either of the recognition result at S10 and the recognition result at step S30.

### (Pattern 3)

The processes are performed in order from steps S20 to S10 to S30. In a manner similar to that in patterns 1 and 2, the recognition process at step S10 is performed using the recognition result at step S20. The recognition process at step S30 is performed using both the recognition result at step S10 and the recognition result at step S20, or either of the recognition result at step S10 and the recognition result at step S20.

### (Pattern 4)

The processes are performed in order from steps S20 to S30 to S10. In a manner similar to that in patterns 1 to 3, the recognition process at step S30 is performed using the recognition result at step S20. The recognition process at step S10 is performed using both the recognition result at step S20 and the recognition result at step S30, or either of the recognition result at step S20 and the recognition result at step S30.

### (Pattern 5)

The processes are performed in order from steps S30 to S10 to S20. In a manner similar to that in patterns 1 to 4, the recognition process at step S10 is performed using the recognition result at step S30. The recognition process at step S20 is performed using both the recognition result at step S10 and the recognition result at step S30, or either of the recognition result at step S10 and the recognition result at step S30.

### (Pattern 6)

The processes are performed in order from steps S30 to S20 to S10. In a manner similar to that in patterns 1 to 5, the recognition process at step S20 is performed using the recognition result at step S30. The recognition process at step S10 is performed using both the recognition result at step S20 and the recognition result at step S30, or either of the recognition result at step S20 and the recognition result at step S30.

### (Pattern 7)

In patterns 1 to 6, a dependent relationship is present among the recognition processes using the respective recognition models. However, in pattern 7, the recognition processes using the respective recognition models are independently performed. That is, the processes at steps S10 to S30 are independently performed. In this case, the recognition processes at steps S10 to S30 may be performed in any order.

Next, the travel lane marking recognition apparatus 20 acquires each vehicle state, that is, the recognition distance, the solid object information, the road surface environment and attributes of the road, the color of the road surface paint, the amount of change in the gradient of the road, the branching road determination result, the vehicle speed, the running state, and the stability of each recognition model (step S40).

Next, the travel lane marking recognition apparatus 20 calculates the integration ratio based on each vehicle state acquired at step S40 and changes the integration ratio to the calculated integration ratio (step S50). The travel lane marking recognition apparatus 20 then integrates the recognition results at steps S10, S20, and S30 based on the integration ratio to which the change has been made at step S50, and recognizes the white line based on the integrated recognition result (step S60). In other words, the travel lane marking recognition apparatus 20 integrates the white line parameters estimated at steps S10, S20, and S30 using the integration ratio to which the change has been made at step S50. The travel lane marking recognition apparatus 20 then ends the present process.

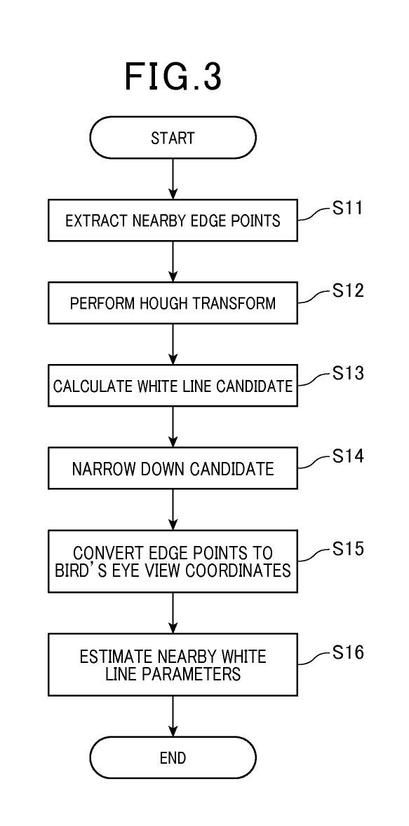

Next, the respective processes for recognizing the white line using the recognition models will be described. Here, a case in which pattern 1 is used will be described as an example. First, the process for recognizing the white line using the short-range model will be described with reference to the flowchart in FIG. 3.

First, the travel lane marking recognition apparatus 20 extracts nearby edge points from a nearby area in the image captured by the on-board camera 10 (step S11). Next, the travel lane marking recognition apparatus 20 performs Hough transform on the edge points detected at S11 and detects a straight line (step S12). The travel lane marking recognition apparatus 20 calculates a straight line of a white line candidate from the detected straight lines (step S13). Specifically, the travel lane marking recognition apparatus 20 sets the straight line having the largest number of votes during Hough transform, among the detected straight lines, as the white line candidate.

Next, the travel lane marking recognition apparatus 20 narrows down the white line candidate (step S14). Specifically, for example, the travel lane marking recognition apparatus 20 limits the white line candidate to a white line candidate of which the contrast ratio in relation to the road surface surrounding the white line candidate in the captured image is higher than a predetermined threshold. Alternatively, the travel lane marking recognition apparatus 20 limits the white line candidate to a white line candidate of which the difference in luminance between the white line candidate portion and the surrounding portion is greater than a predetermined threshold. Furthermore, the white line candidate may be narrowed down taking into consideration various features that indicate a likeness to the white line, such as the thickness of the line and the lane width. The travel lane marking recognition apparatus 20 selects the closest white line candidates in the leftward and rightward directions from the center of the vehicle.

Next, the travel lane marking recognition apparatus 20 converts the edge points configuring the white line candidates to which narrowing down had been performed at step S14 to bird's eye view coordinates (step S15). The bird's eye view coordinates are coordinates based on an assumption that the road surface is flat.

Next, the travel lane marking recognition apparatus 20 estimates the nearby white line parameters using a known method, from the edge points in the bird's eye view coordinates to which conversion had been performed at step S15 (step S16). Specifically, the travel lane marking recognition apparatus 20 estimates the nearby white line parameters using the edge points in the bird's eye view coordinates to which conversion had been performed at step S15, the edge points extracted in the past, and the yaw rate of the vehicle. The nearby white line parameters are the lane position, the lane tilt, the lane curvature, and the lane width. The travel lane marking recognition apparatus 20 then ends the present process.

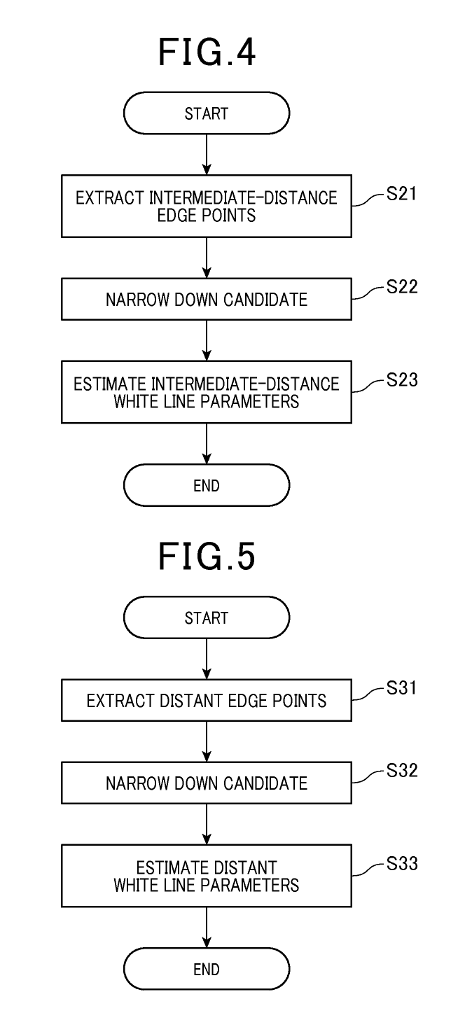

Next, the process for recognizing the white line using the medium-range model will be described with reference to the flowchart in FIG. 4. Here, the second-order model is assumed for the medium-range model.

First, the travel lane marking recognition apparatus 20 extracts intermediate-distance edge points from an intermediate-distance area in the image captured by the on-board camera (step S21). Next, the travel lane marking recognition apparatus 20 narrows down the edge points extracted at step S21 to edge points that are present in an area in which the likelihood of the edge point being noise is low, using the nearby white line parameters estimated during the nearby white line recognition process (step S22). Specifically, the travel lane marking recognition apparatus 20 circumscribes the position at which a white line is expected to be present based on the lane position and the lane width included in the nearby white line parameters, and selects the edge points corresponding to the circumscribed position. In addition, the travel lane marking recognition apparatus 20 may narrow down the edge points taking into consideration various features that indicate a likeness to the white line.

Next, the travel lane marking recognition apparatus 20 approximates the edge points to which narrowing down had been performed at step S22, using a secondary expression, and estimates intermediate-distance white line parameters (step S23). The travel lane marking recognition apparatus 20 then ends the present process.

Next, the process for recognizing the white line using the long-range model will be described with reference to the flowchart in FIG. 4. Here, the third-order model is assumed for the long-range model.

First, the travel lane marking recognition apparatus 20 extracts distant edge points from a distant area in the image captured by the on-board camera (step S31). Next, in a manner similar to the process at step S22 in the flowchart in FIG. 4, the travel lane marking recognition apparatus 20 narrows down the edge points extracted at step S31 using the intermediate-distance white line parameters estimated during the intermediate-distance white line recognition process (step S32).

Next, the travel lane marking recognition apparatus 20 approximates the edge points to which narrowing down had been performed at step S32, using a tertiary expression, and estimates distant white line parameters (step S33). The travel lane marking recognition apparatus 20 then ends the present process.

According to the first embodiment described above, the following effects are achieved.

The white line is recognized by recognition results acquired using a plurality of recognition models being integrated based on the vehicle state. Therefore, a highly robust recognition of white lines can be actualized in various vehicle states.

The integration ratio of the recognition results acquired using the plurality of recognition models is changed depending on the vehicle state. Therefore, a highly robust recognition of white lines can be actualized.

As the recognition distance becomes shorter, the white line cannot be recognized over a long distance. Therefore, use of the low-order model is appropriate. Thus, white lines can be stably recognized by the recognition distance being used as the vehicle state.

As the vehicle speed decreases, the traffic state becomes closer to a state of congestion. Therefore, use of the low-order model is appropriate. Meanwhile, as the vehicle speed increases, the white line can be seen over a long distance. Therefore, use of the high-order model is appropriate. Thus, white lines can be stably recognized by the vehicle speed being used as the vehicle state.

As the number of solid objects in the periphery of the vehicle increases, the white line cannot be recognized over a long distance. Therefore, use of the low-order model is appropriate. Thus, white lines can be stably recognized by the solid object information on the periphery of the vehicle being used as the vehicle state.

In a road surface environment in which the white line is difficult to recognize, such as on a wet road surface, a snowy road, or a gravel road, use of the low-order model is appropriate. In addition, more obstructions are present on local roads than on expressways, and the white line cannot be recognized over a long distance. Therefore, use of the low-order model is appropriate. Furthermore, mountain roads have numerous curves. Therefore, use of the high-order model is appropriate. Thus, white lines can be stably recognized by the road surface environment or road information on road attributes being used as the vehicle state.

When the lane is a branching road, a white line farther than the branching portion is required to be recognized in order to stably recognize white lines. To recognize a white line farther than the branching portion, use of the high-order model is appropriate. Thus, white lines can be stably recognized by the branching road determination result being used as the vehicle state.

When the road surface paint on the road is yellow, the yellow road surface paint may indicate that a construction zone is present up ahead. In the construction zone, numerous obstructions are present. Therefore, use of the low-order model is appropriate. Thus, white lines can be stably recognized by the color information on road surface paint being used as the vehicle state.

In a location where the gradient of the road significantly changes, such as at an entrance to a slope, a distant white line is easily erroneously recognized. Therefore, use of the low-order model is appropriate. Thus, white lines can be stably recognized by the amount of change in the gradient being used as the vehicle state.

Through preferential use of a recognition model that enables stable recognition of white lines, among the plurality of recognition models, stability of white line recognition improves. Thus, white lines can be stably recognized by the stability of white line recognition of each recognition model being used as the vehicle state.

When the vehicle is pitching or rolling, or when the vehicle skids on the road surface, and the vehicle is running in an unstable state, erroneous recognition easily occurs when a distant white line is recognized. Therefore, use of the low-order model is appropriate. Thus, white lines can be stably recognized by the running state of the vehicle being used as the vehicle state.

### Second Embodiment

Regarding a travel lane marking recognition apparatus 20A according to a second embodiment, the differences with the travel lane marking recognition apparatus 20 according to the first embodiment will be described.

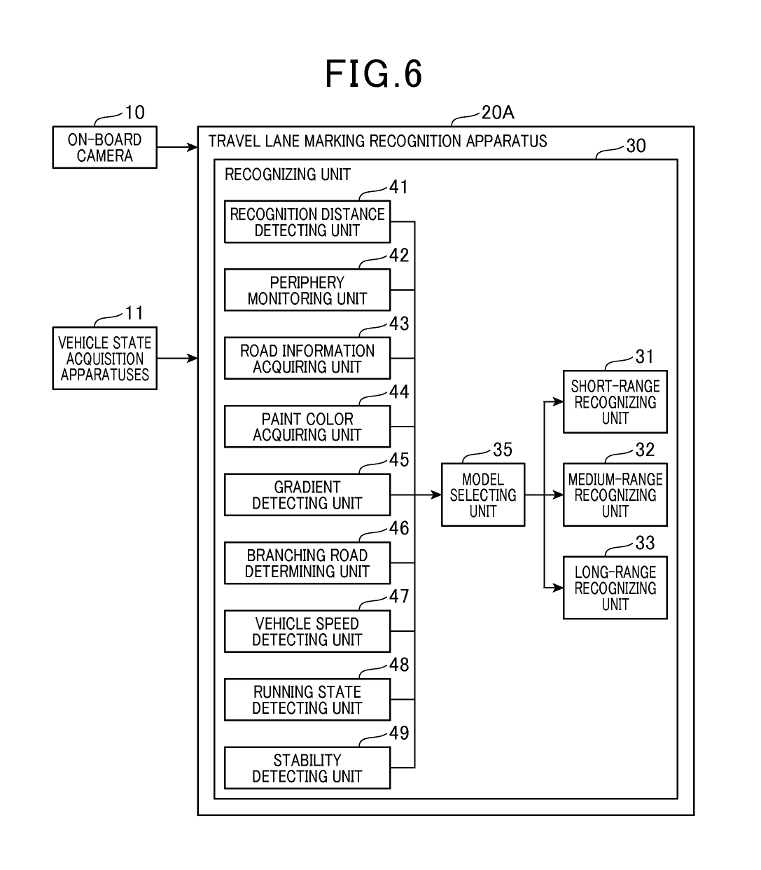

As shown in FIG. 6, a recognizing unit 30 of the travel lane marking recognition apparatus 20A includes a model selecting unit 35, instead of the recognition integrating unit 34 and the integration ratio calculating unit 50. The model selecting unit 35 selects the recognition model to be used based on the vehicle state. Specifically, in a manner similar to the integration ratio calculating unit 50, the model selecting unit 35 calculates the usage ratio of each recognition model, and selects the recognition model having the highest usage ratio.

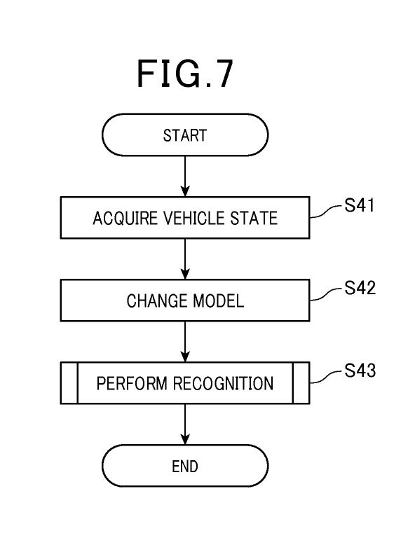

Next, a process for recognizing a white line will be described with reference to the flowchart in FIG. 7. The present process is performed by the travel lane marking recognition apparatus 20A each time an image is captured by the on-board camera 10.

First, the travel lane marking recognition apparatus 20A acquires each vehicle state, that is, the recognition distance, the solid object information, the road surface environment and attributes of the road, the color of the road surface paint, the amount of change in the gradient of the road, the branching road determination result, the vehicle speed, the running state, and the stability of each recognition model (step S41).

Next, the travel lane marking recognition apparatus 20A changes the recognition model to be used based on the vehicle states acquired at step S41 (step S42). Then, the travel lane marking recognition apparatus 20A recognizes the white line using the recognition model to which the change had been made at step S42 (step S43). That is, the travel lane marking recognition apparatus 20A performs any of the nearby white line recognition process, the intermediate-distance white line recognition process, and the distant white line recognition process, and calculates the white line parameters. The travel lane marking recognition apparatus 20A then ends the present process.

According to the second embodiment described above, in a manner similar to that according to the first embodiment, highly robust white line recognition can be actualized in various vehicle states.

### Other Embodiments

According to the first embodiment, the integration ratio is merely required to be calculated based on at least a single vehicle state among the vehicle states.

According to the second embodiment, the recognition model to be used is merely required to be changed based on at least a single vehicle state among the vehicle states.

The plurality of recognition models is merely required to include at least two recognition models among the short-range model, the medium-range model, and the long-range model. That is, the plurality of recognition models may be two models: the short-range model and the long-range model. Alternatively, the plurality of recognition models may be two models: the medium-range model and the long-range model. Moreover, the plurality of recognition models may be two models: the short-range model and the medium-range model.

What is claimed is:

1. A travel lane marking recognition apparatus comprising:
a recognizing unit that is mounted to a vehicle and uses a recognition model to recognize a lane marking that demarcates a lane on a road, based on an image of an area ahead of the vehicle captured by an on-board camera,
the recognition model being configured by a plurality of recognition models that includes at least two recognition models among a first-order model that takes into consideration a straight line, a second-order model that takes into consideration a steady curve, and a third-order model that takes into consideration a clothoid curve,
the recognizing unit being configured to recognize the lane marking by integrating recognition results acquired using the plurality of recognition models based on a state of the vehicle.

2. A travel lane marking recognition apparatus comprising:
a recognizing unit that is mounted to a vehicle and uses a recognition model to recognize a lane marking that demarcates a lane on a road, based on an image of an area ahead of the vehicle captured by an on-board camera,
the recognition model being configured by a plurality of recognition models that includes at least two recognition models among a first-order model that takes into consideration a straight line, a second-order model that takes into consideration a steady curve, and a third-order model that takes into consideration a clothoid curve,
the recognizing unit being configured to recognize the lane marking by changing the plurality of recognition models to be used based on a state of the vehicle.

3. A travel lane marking recognition apparatus comprising:
a recognizing unit that is mounted to a vehicle and uses a recognition model to recognize a lane marking that demarcates a lane on a road, based on an image of an area ahead of the vehicle captured by an on-board camera,
the recognition model being configured by a plurality of recognition models that includes at least two recognition models among a short-range model specific for short distances, a medium-range model specific for intermediate distances, and a long-range model specific for long distances,
the recognizing unit being configured to recognize the lane marking by integrating recognition results acquired using the plurality of recognition models based on a state of the vehicle.

4. A travel lane marking recognition apparatus comprising:
a recognizing unit that is mounted to a vehicle and uses a recognition model to recognize a lane marking that demarcates a lane on a road, based on an image of an area ahead of the vehicle captured by an on-board camera,
the recognition model being configured by a plurality of recognition models that includes at least two recognition models among a short-range model specific for short distances, a medium-range model specific for intermediate distances, and a long-range model specific for long distances,
the recognizing unit being configured to recognize the lane marking by changing the plurality of recognition models to be used based on a state of the vehicle.

5. The travel lane marking recognition apparatus according to claim 1, wherein
the recognizing unit is configured to change an integration ratio of the recognition results acquired using the plurality of recognition models, based on the state of the vehicle.

6. The travel lane marking recognition apparatus according to claim 1, further comprising
a recognition distance detecting unit that detects a recognition distance, the recognition distance being a distance at which the lane marking is recognized,
the recognizing unit being configured to use, as the state of the vehicle, the recognition distance detected by the recognition distance detecting unit.

7. The travel lane marking recognition apparatus according to claim 1, further comprising
a vehicle speed detecting unit that detects a speed of the vehicle,
the recognizing unit being configured to use, as the state of the vehicle, the speed of the vehicle detected by the vehicle speed detecting unit.

8. The travel lane marking recognition apparatus according to claim 1, further comprising
a solid object information acquiring unit that acquires solid object information of a periphery of the vehicle,
the recognizing unit being configured to use, as the state of the vehicle, the solid object information acquired by the solid object information acquiring unit.

9. The travel lane marking recognition apparatus according to claim 1, further comprising
a road information acquiring unit that acquires a road surface environment of the road or an attributes of the road,
the recognizing unit being configured to use, as the state of the vehicle, the road surface environment of the road or the attributes of the road acquired by the road information acquiring unit.

10. The travel lane marking recognition apparatus according to claim 1, further comprising
a branching road determining unit that determines whether or not the lane is a branching road,
the recognizing unit being configured to use, as the state of the vehicle, a determination result of the branching road determining unit.

11. The travel lane marking recognition apparatus according to claim 1, further comprising
a color acquiring unit that acquires color information of a surface paint of the road,
the recognizing unit being configured to use, as the state of the vehicle, the color information of the surface paint of the road acquired by the color acquiring unit.

12. The travel lane marking recognition apparatus according to claim 1, further comprising
a gradient detecting unit that detects an amount of change in gradient of the road,
the recognizing unit being configured to use, as the state of the vehicle, the amount of change in gradient of the road acquired by the gradient detecting unit.

13. The travel lane marking recognition apparatus according to claim 1, further comprising
a stability detecting unit that detects a stability of recognition of the lane marking for each of the plurality of recognition models,
the recognizing unit being configured to use, as the state of the vehicle, the stability of recognition of the lane marking detected by the stability detecting unit.

14. The travel lane marking recognition apparatus according to claim 1, further comprising
a running state detecting unit that detects a running state of the vehicle,
the recognizing unit being configured to use, as the state of the vehicle, the running state of the vehicle detected by the running state detecting unit.

15. The travel lane marking recognition apparatus according to claim 3, wherein
the recognizing unit is configured to change an integration ratio of the recognition results acquired using the plurality of recognition models, based on the state of the vehicle.

16. The travel lane marking recognition apparatus according to claim 2, further comprising at least one of:
a recognition distance detecting unit that detects a recognition distance, the recognition distance being a distance at which the lane marking is recognized;
a vehicle speed detecting unit that detects a speed of the vehicle;
a solid object information acquiring unit that acquires solid object information of a periphery of the vehicle;
a road information acquiring unit that acquires a road surface environment of the road or an attributes of the road;
a branching road determining unit that determines whether or not the lane is a branching road;
a color acquiring unit that acquires color information of a surface paint of the road;
a gradient detecting unit that detects an amount of change in gradient of the road;
a stability detecting unit that detects a stability of recognition of the lane marking for each of the plurality of recognition models; and
a running state detecting unit that detects a running state of the vehicle,
the recognizing unit being configured to use, as the state of the vehicle, at least one of
the recognition distance detected by the recognition distance detecting unit,
the speed of the vehicle detected by the vehicle speed detecting unit,
the solid object information acquired by the solid object information acquiring unit,
the road surface environment of the road or the attributes of the road acquired by the road information acquiring unit,
a determination result of the branching road determining unit,
the color information of the surface paint of the road acquired by the color acquiring unit,
the amount of change in gradient of the road acquired by the gradient detecting unit,
the stability of recognition of the lane marking detected by the stability detecting unit, and
the running state of the vehicle detected by the running state detecting unit.

17. The travel lane marking recognition apparatus according to claim 3, further comprising at least one of:
a recognition distance detecting unit that detects a recognition distance, the recognition distance being a distance at which the lane marking is recognized;
a vehicle speed detecting unit that detects a speed of the vehicle;
a solid object information acquiring unit that acquires solid object information of a periphery of the vehicle;
a road information acquiring unit that acquires a road surface environment of the road or an attributes of the road;
a branching road determining unit that determines whether or not the lane is a branching road;
a color acquiring unit that acquires color information of a surface paint of the road;
a gradient detecting unit that detects an amount of change in gradient of the road;
a stability detecting unit that detects a stability of recognition of the lane marking for each of the plurality of recognition models; and
a running state detecting unit that detects a running state of the vehicle, the recognizing unit being configured to use, as the state of the vehicle, at least one of
the recognition distance detected by the recognition distance detecting unit,
the speed of the vehicle detected by the vehicle speed detecting unit,
the solid object information acquired by the solid object information acquiring unit,
the road surface environment of the road or the attributes of the road acquired by the road information acquiring unit,
a determination result of the branching road determining unit,
the color information of the surface paint of the road acquired by the color acquiring unit,
the amount of change in gradient of the road acquired by the gradient detecting unit,
the stability of recognition of the lane marking detected by the stability detecting unit, and
the running state of the vehicle detected by the running state detecting unit.

18. The travel lane marking recognition apparatus according to claim 4, further comprising at least one of:
a recognition distance detecting unit that detects a recognition distance, the recognition distance being a distance at which the lane marking is recognized;
a vehicle speed detecting unit that detects a speed of the vehicle;
a solid object information acquiring unit that acquires solid object information of a periphery of the vehicle;
a road information acquiring unit that acquires a road surface environment of the road or an attributes of the road;
a branching road determining unit that determines whether or not the lane is a branching road;
a color acquiring unit that acquires color information of a surface paint of the road;
a gradient detecting unit that detects an amount of change in gradient of the road;
a stability detecting unit that detects a stability of recognition of the lane marking for each of the plurality of recognition models; and
a running state detecting unit that detects a running state of the vehicle,
the recognizing unit being configured to use, as the state of the vehicle, at least one of
the recognition distance detected by the recognition distance detecting unit,
the speed of the vehicle detected by the vehicle speed detecting unit,
the solid object information acquired by the solid object information acquiring unit,
the road surface environment of the road or the attributes of the road acquired by the road information acquiring unit,
a determination result of the branching road determining unit,
the color information of the surface paint of the road acquired by the color acquiring unit,
the amount of change in gradient of the road acquired by the gradient detecting unit,
the stability of recognition of the lane marking detected by the stability detecting unit, and
the running state of the vehicle detected by the running state detecting unit.
